(19) United States
(12) Patent Application Publication
(10) Pub. No.: US 2012/0174187 A1
(43) Pub. Date: Jul. 5, 2012

(54) SYSTEMS AND METHODS FOR PROVIDING PHYSICAL LAYER SECURITY

(75) Inventors: Cenk Argon, Chapel Hill, NC (US); Steven William Mclaughlin, Decatur, GA (US); Demijan Kling, San Francisco, CA (US)

(73) Assignee: GEORGIA TECH RESEARCH CORPORATION, Atlanta, GA (US)

(21) Appl. No.: 13/382,715

(22) PCT Filed: Jul. 9, 2010
(86) PCT No.: PCT/US10/41501

§ 371 Date: Mar. 21, 2012

Related U.S. Application Data
(60) Provisional application No. 61/224,261, filed on Jul. 9, 2009.

(51) Int. Cl. G06F 21/00

(52) U.S. Cl. 726/2

(57) ABSTRACT

The present invention describes systems and methods for providing physical layer security. An exemplary embodiment of the present invention provides a method of providing physical layer security involving receiving message data at a pre-processing device in a wireless transmission device. Furthermore, the method of providing physical layer security involves pre-processing the message data into channel data with the pre-processing device and transmitting the channel data from the wireless transmission device over a wireless transmission link having a path loss. Subsequently, the method of providing physical layer security involves receiving the channel data at a post-processing module in a reception device. Additionally, the method involves post-processing the channel data into the message data with the post-processing module, such that an unauthorized reception device is unable to post-process the channel data when a path loss experienced over the transmission link is greater than a predetermined value.

### CROSS REFERENCE TO RELATED APPLICATIONS

This application claims the benefit of U.S. Provisional Patent Application No. 60/224,261, filed 9 Jul. 2009, which is hereby incorporated by reference in its entirety as if fully set forth below.

### FIELD OF THE INVENTION

The present invention relates generally to systems and methods for providing telecommunication security systems and, more particularly, to systems and methods for providing secure physical layer communication systems.

### BACKGROUND

With the rapid development of wireless communications, users are increasingly relying upon wireless telecommunication for critical information transmission, including financial, confidential, and personal information. Wireless security for this critical information transmission has become increasingly important. Conventional secure wireless communication techniques generally rely upon secure codes or keys to prevent unwanted eavesdroppers from gaining access to the information transmitted over a wireless link.

For example, in a typical wireless communication system, a session key is distributed among the transmitting and receiving communication devices when a communication session is set up. The session key is then used by the transmitting communication to perform encryption at an upper layer of the Open Systems Interconnection (“OSI”) model, such as the application and transport layers. More complex asymmetric key algorithms, such as public key cryptography rely upon both a public key and a private key. For public key cryptography, a message can be encrypted using a public key, but can only be decrypted using a private key.

Secure communications using cryptography, such as public key methods, rely on the existence of a code that is computationally infeasible to invert, i.e. hard to break. This type of cryptography, however, is vulnerable to an increase in computing power or the development of a more efficient attempt to crack the code. To prevent security breaches, cryptography methods are continually seeking to generate larger and more complex randomly chosen keys and codes as the basis for encryption. The complexity of the encryption scheme, however, is directly proportional to the expense of the system required to support the encryption scheme. Thus, it is desired to provide physical layer security to supplement and support conventional higher layer encryption techniques.

Therefore, it would be advantageous to provide an apparatus and method for efficiently and effectively providing secure wireless communication systems at the physical layer.

Additionally, it would be advantageous to provide an apparatus and method to provide a secure wireless communication without the need for an encrypted and/or secret key.

### BRIEF SUMMARY

The present invention describes systems and methods for providing physical layer security. An exemplary embodiment of the present invention provides a method of providing physical layer security involving receiving message data at a pre-processing device in a wireless transmission device. Furthermore, the method of providing physical layer security involves pre-processing the message data into channel data with the pre-processing device and transmitting the channel data from the wireless transmission device over a wireless transmission link having a path loss. Subsequently, the method of providing physical layer security involves receiving the channel data at a post-processing module in a reception device. Additionally, the method involves post-processing the channel data into the message data with the post-processing module, such that an unauthorized reception device is unable to post-process the channel data when a path loss experienced over the transmission link is greater than a predetermined value.

In addition to methods of providing physical layer security, the present invention provides a secure physical layer communication system including a first shift-register device and a Last-In First-Out (“LIFO”) memory device in communication with the first shift-register device. Furthermore, the secure physical layer communication system includes a second shift-register device in communication with the Last-In First-Out (“LIFO”) memory device.

These and other objects, features and advantages of the present invention will become more apparent upon reading the following specification in conjunction with the accompanying drawing figures.

### BRIEF DESCRIPTION OF THE FIGURES

FIG. 1 provides an illustration of the layout of a typical wireless network 105.

FIG. 2 provides an illustration of secure physical layer pre-processing device 200 in accordance with an exemplary embodiment of the present invention.

FIG. 3 provides an illustration of secure physical layer post-processing device 300 in accordance with an exemplary embodiment of the present invention.

FIG. 4 provides an illustration of block diagram of the components of the secure physical layer pre-processing device 200 in accordance with an exemplary embodiment of the present invention.

FIG. 5 provides an illustration of block diagram of the components of the secure physical layer post-processing device 300 in accordance with an exemplary embodiment of the present invention.

FIG. 6 provides an illustration of block diagram of the components of the secure physical layer pre-processing device 200 in accordance with an exemplary embodiment of the present invention.

FIG. 7 provides an illustration of block diagram of the components of the secure secure physical layer post-processing device 300 in accordance with an exemplary embodiment of the present invention.

FIG. 8 provides graphs of the detected BER (p′) for both conventional reception devices and reception devices having a secure physical layer post-processing device 300.

FIG. 9 is a graph of the number of channel bits (w) processed by a reception device, implementing a random matrix multiplier as a pre-processing device, versus the bit position.

FIG. 10 is a graph of the number of channel bits (w) processed by a reception device including a secure physical layer post-processing device 300 receiving data from a transmission device including a secure physical layer pre-processing device 200.

FIG. 11 is a graph of the number of channel bits (w) processed by a reception device including a secure physical layer post-processing device 300 receiving data from a transmission device including a secure physical layer pre-processing device 200.

FIG. 12 provides an illustration of a block diagram of the method of providing physical layer security 1200 in accordance with an exemplary embodiment of the present invention.

FIG. 13 provides an illustration of block diagram of the components of the secure physical layer pre-processing device 200 including a high-degree Linear Shift-Registers (“LSR”) 405 in accordance with an exemplary embodiment of the present invention.

FIG. 14 provides an illustration of block diagram of the components of the secure physical layer post-processing device 300 including a high-degree Linear Feedback Shift-Registers (“LFSR”) 505 in accordance with an exemplary embodiment of the present invention.

FIG. 15 is a graph of the number of channel bits (w) processed by a reception device including a secure physical layer post-processing device 300 receiving data from a transmission device including a secure physical layer pre-processing device 200.

FIG. 16 provides an illustration of block diagram of the secure physical layer communication system 100, which can function as both a secure physical layer pre-processing device 200 and a secure physical layer post-processing device 300 in accordance with an exemplary embodiment of the present invention.

FIG. 17 provides an illustration of block diagram of recursive nature of the shift-register in the secure physical layer communication system 100 shown in FIG. 16.

FIG. 18 is a graph of the post-processing matrix density showing non-zero matrix entries for an exemplary embodiment of the secure physical layer communication system 100.

FIG. 19 provides an illustration of block diagram of the secure physical layer communication system 100 in accordance with an exemplary embodiment of the present invention.

FIG. 20 provides an illustration of block diagram of the secure physical layer communication system 100 in accordance with an exemplary embodiment of the present invention.

### DETAILED DESCRIPTION

The present invention addresses the deficiencies in the prior art concerning the inability to provide physical layer security. Significantly, the present invention provides methods and apparatus for secure physical layer communication without the need for a secret key or code. A secure physical layer communication system provided in accordance with the present invention is enabled to pre-process data for transmission using relatively simple and inexpensive hardware. The method of secure physical layer communication enabled by an exemplary embodiment of the present invention involves pre-processing data with a pre-processing device in a transmission device and post-processing data with a post-processing device in a reception device. An exemplary embodiment of the method of providing physical layer security relies upon the path loss of a given wireless transmission link to induce unknown error in the channel data received by an eavesdropper.

The secure physical layer communication systems enabled by the present invention present significant advantages to wireless communication systems. Because the secure physical layer communication systems enabled by the present invention process data on the physical layer, they can be implemented without modifications to the transmission protocols in the transmission or network layers or modifications to the applications in the presentation or application layers. The secure physical layer communication capabilities provided by the exemplary embodiment of the present invention can be implemented in a wide variety of wireless networks and wireless devices, including personal computing devices, mobile phones, and other telecommunication equipment.

Importantly, an exemplary embodiment of the secure physical layer communication system does not rely upon a secret key or code, but rather the unpredictable path loss of given wireless transmission link to prevent unauthorized access to the information or message data transmitted. Those of skill in the art will appreciate that wireless transmission links experience a certain amount of path loss. This path loss can generally be characterized by the distance of the reception device from the transmission device in relation to a path loss exponent. The path loss exponent (a) can be used to describe the reduction in power density (attenuation) of an electromagnetic wave as it propagates through space, i.e., the rate at which wireless received signal strength (“RSS”) decreases with distance. The path loss exponent (a) can include propagation losses caused by the natural expansion of the radio wave front in free space, absorption losses, when the signal passes through media not transparent to electromagnetic waves, diffraction losses when part of the radiowave front is obstructed by an opaque obstacle, and losses caused by other phenomena. Path loss is dynamic and unpredictable, as it varies by time, location, temperature, transmission protocols, and a wide variety of ever changing interferences and other factors.

The exemplary embodiments of the secure physical layer communication systems exploit path loss as the basis for secure transmission. In an exemplary embodiment, the secure physical layer communication system provides a secure physical layer pre-processing device to process the data at the physical layer level before modulation. For this exemplary embodiment, the resulting pre-processed channel data cannot be post-processed by an unauthorized reception device experiencing path loss above a predetermined threshold. Significantly, in accordance with exemplary embodiment of the present invention, the predetermined threshold for the path loss is relatively low, as the eavesdropper will experience an increased Bit Error Rate (“BER”) at a relatively short distance from the transmission device due to the secure physical layer pre-processing device. In one embodiment, the eavesdropper operating an unauthorized reception device will experience a BER=0.5 at distances less than 1.25 meters from the transmission device of the secure physical layer communication system.

One of the significant advantages of the secure physical layer communication system enabled by the present invention is that there is no need to keep the architecture of the secure physical layer communication system a secret. In an exemplary embodiment of the secure physical layer communication system, even an eavesdropper knowing the configuration of the secure physical layer pre-processing device will be unable to accurately and efficiently post-process the data pre-processed by the secure physical layer pre-processing device. Additionally, unlike many conventional cryptography and secure communication techniques, there is no secret key or code to protect with the exemplary embodiments of the secure physical layer communication system.

An exemplary embodiment of the present invention provides a method of providing physical layer security involving receiving message data at a pre-processing device in a wireless transmission device. Furthermore, the method of providing physical layer security involves pre-processing the message data into channel data with the pre-processing device and transmitting the channel data from the wireless transmission device over a wireless transmission link having a path loss. Subsequently, the method of providing physical layer security involves receiving the channel data at a post-processing module in a reception device. Additionally, the method involves post-processing the channel data into the message data with the post-processing module, such that an unauthorized reception device is unable to post-process the channel data when a path loss experienced over the transmission link is greater than a predetermined value.

In addition to methods of providing physical layer security, the present invention provides a secure physical layer communication system including a first shift-register device and a Last-In First-Out (“LIFO”) memory device in communication with the first shift-register device. Furthermore, the secure physical layer communication system includes a second shift-register device in communication with the Last-In First-Out (“LIFO”) memory device.

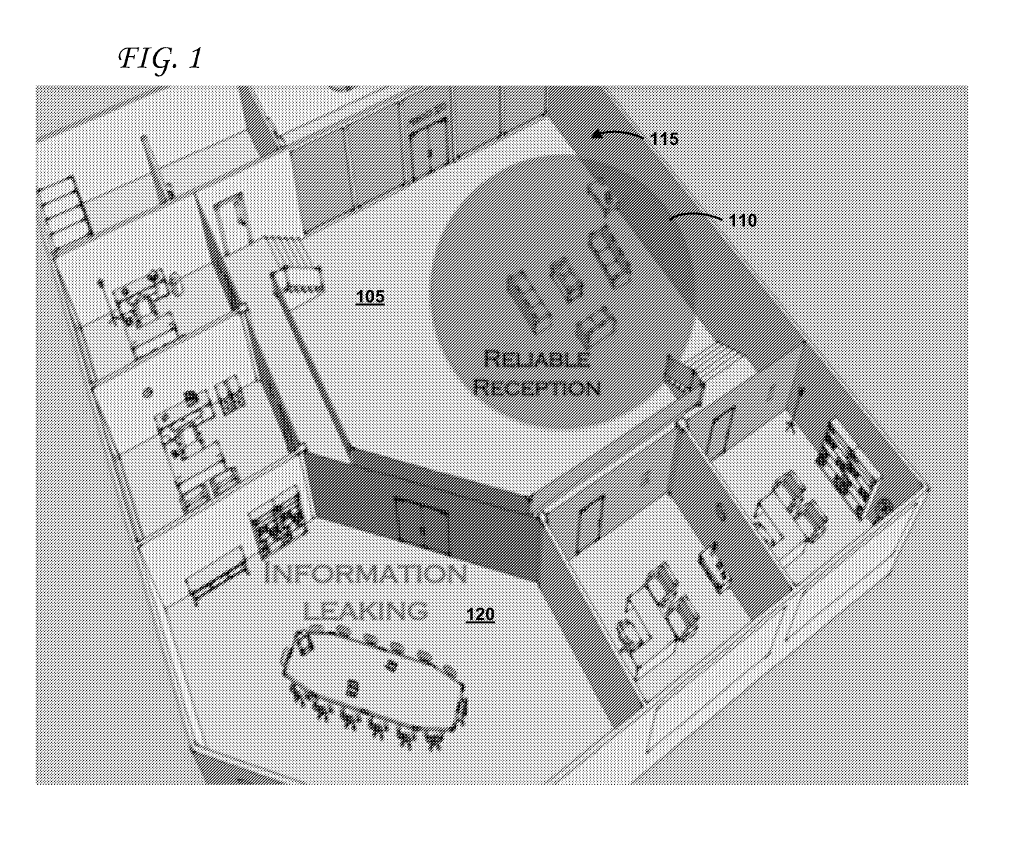

FIG. 1 provides an illustration of the layout of a typical wireless network 105. The wireless network 105 can reliably provide wireless service to wireless devices inside the reliable reception area 110. Users of wireless devices inside this reliable reception area 110 may reliably receive data from the wireless network 105. In some embodiments, the reliable reception area 110 is in a restricted zone 115, in which only authorized individuals may enter and thus gain access to the wireless network 105. Unfortunately, the wireless network 105 may be broadcast beyond the restricted zone 115 and thus can be accessed by an eavesdropper outside the restricted zone 115. In many circumstances, the eavesdropper may receive a degraded signal from the wireless network 105, as the eavesdropper is outside the reliable reception area 110, but the eavesdropper may still be able to successfully capture the wireless data in the information leakage area 120. Therefore, a secure method of operating the wireless network 105 is desired to prevent eavesdroppers from gaining access to the wireless network 105 in the information leakage area 120.

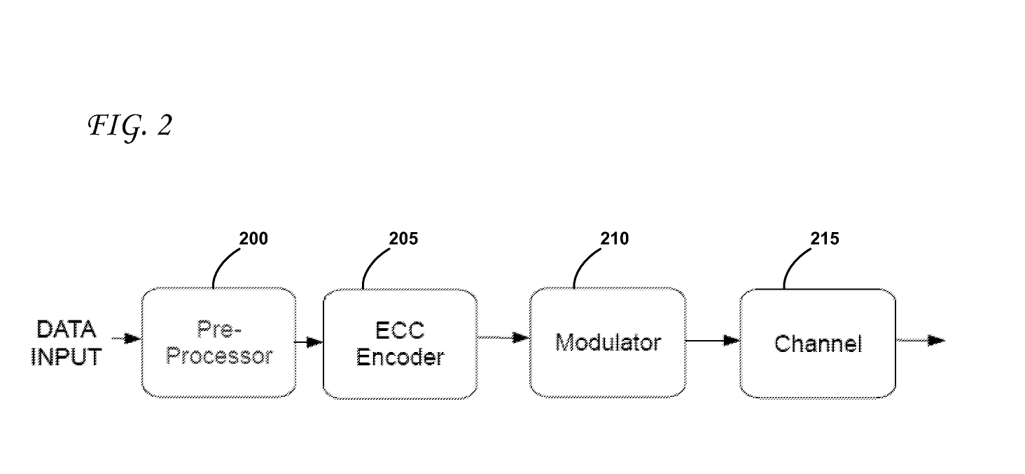

FIG. 2 provides an illustration of secure physical layer pre-processing device 200 in accordance with an exemplary embodiment of the present invention. Typically, a conventional transmission device for a wireless network 105 operating without physical layer security will include an Error Correction Code (“ECC”) Encoder module 205, such as Reed-Solomon codes, BCH codes, the binary Golay code, a binary Goppa code. In one example, the ECC Encoder module 205 can encode the incoming message data using an error-correcting code prior to transmission, and the additional information (redundancy) added by the error-correcting code can be used by a reception device to recover the original data. While these exemplary error-correcting codes can aid in error detection and correction, they do not provide a secure physical layer for wireless network data transmission. Additionally, the conventional transmission device will include a modulator 210 and channel module 215 to output the data from the transmission device. In accordance with an exemplary embodiment of the present invention, a transmission device is provided that includes a secure physical layer pre-processing device 200. In an exemplary embodiment, the secure physical layer pre-processing device 200 can enable a security at the physical layer of the transmission in a wireless network 105 by pre-processing the data to be transmitted. Those of skill in the art will appreciate that the transport data can be pre-processed in a variety of ways without detracting from the scope of this invention. For example, in some embodiments, a Linear Shift-Registers (“LSR”) and interleavers are used to pre-process the transport data. Those of skill in the art will appreciate that a large variety of LSRs and interleavers could be implemented in various embodiments. In some embodiments, the data is rearranged by the secure physical layer pre-processing device 200 with little or no error data or new data being inserted into the transport stream.

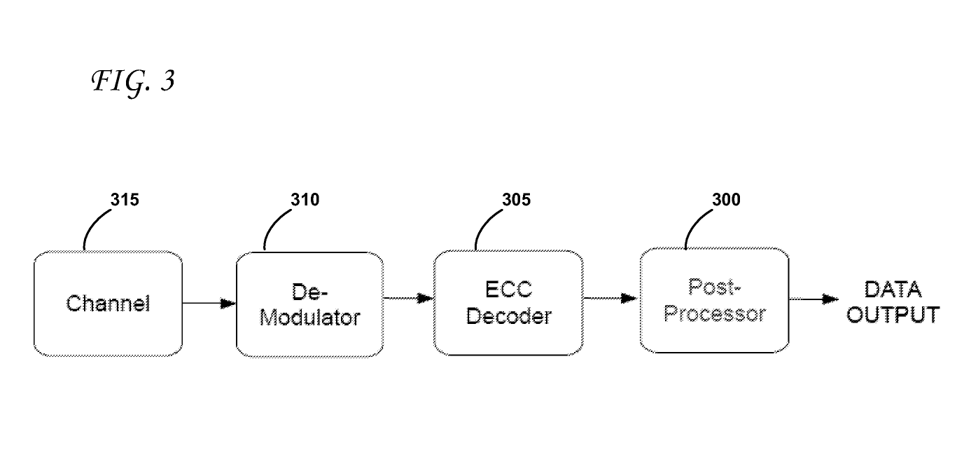

FIG. 3 provides an illustration of secure physical layer post-processing device 300 in accordance with an exemplary embodiment of the present invention. Typically, a conventional transmission device for a wireless network 105 operating without physical layer security will include a ECC Decoder module 305, to decode the error-correcting code in the data of the transport stream received by the reception device. Additionally, the conventional transmission device will include a de-modulator 310 and channel module 315 to receive the incoming channel data. While the ECC Decoder can aid in error detection and correction, it does not provide a secure physical layer for wireless network data transmission. In accordance with an exemplary embodiment of the present invention, a reception device is provided that includes a secure physical layer post-processing device 300. In an exemplary embodiment, the secure physical layer post-processing device 300 can enable a security at the physical layer of the transmission in a wireless network 105 by post-processing the channel data received by the reception device. Those of skill in the art will appreciate that the channel data can be post-processed in way that corresponds to the pre-proccessing method implemented by the secure physical layer pre-processing device 200 to pre-process the message data. For example, in some embodiments, a Linear Feedback Shift-Registers (“LFSR”) and interleavers are used to post-process the transport data received by the reception device. Those of skill in the art will appreciate that a large variety of LFSRs and interleavers could be implemented in various embodiments.

Those of skill in the art will appreciate that exemplary embodiments of the secure physical layer communication system 100 can include one or both of either the secure physical layer pre-processing device 200 and the secure physical layer post-processing device 300.

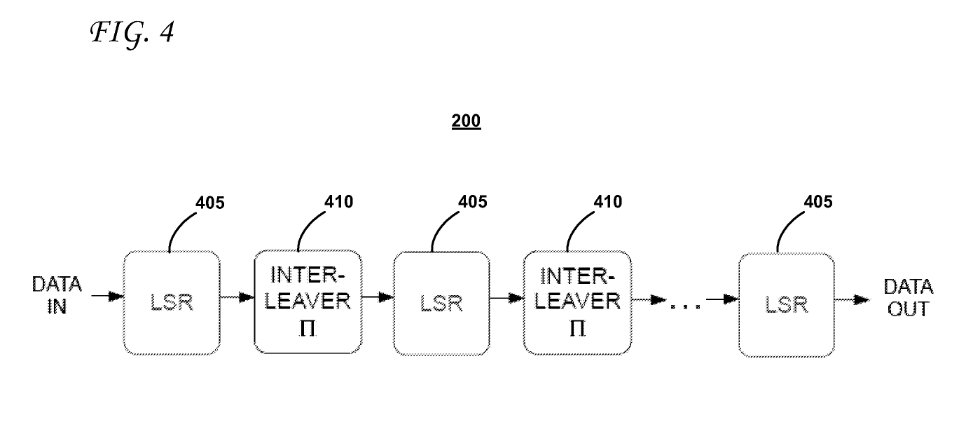

FIG. 4 provides an illustration of block diagram of the components of the secure physical layer pre-processing device 200 in accordance with an exemplary embodiment of the present invention. As shown in the exemplary embodiment in FIG. 4, the secure physical layer pre-processing device 200 can include one or more LSRs 405 and one or more interleavers 410. Those of skill in the art will appreciate that the interleavers 410 can be a many different types of interleavers, including the random interleavers depicted in FIG. 4. In the exemplary embodiment shown in FIG. 4, the secure physical layer pre-processing device 200 receives the input data to first LSR 405, which outputs data to a first interleaver 410. The first interleaver 410 then outputs data to a second LSR 405, which outputs data to a second interleaver 410. Thus, the exemplary embodiment of the secure physical layer pre-processing device 200 provides a cascade of LSRs 405 and interleavers 410 to pre-process the data to be transmitted by the transmission device configured with the exemplary embodiment of the secure physical layer pre-processing device 200. In accordance with an exemplary embodiment of the secure physical layer pre-processing device 200, the longer the cascade (i.e., the more LSRs 405 and interleavers 410), the greater the physical layer security there is for each bit position. Those of skill in the art will appreciate that different implementations of the secure physical layer pre-processing device 200 can include different numbers of LSRs 405 and interleavers 410 in the cascade of the pre-processing device 200, depending upon the complexity and the desired tolerances of the implementation.

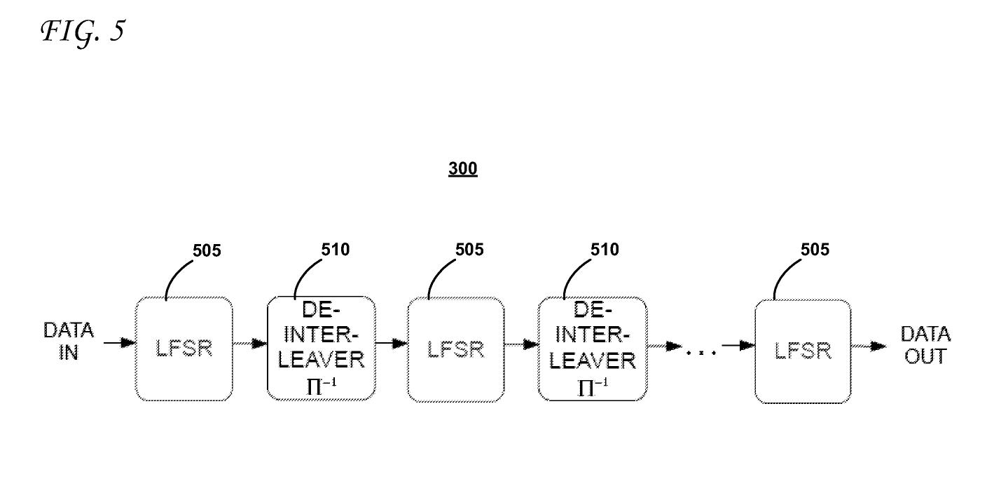

FIG. 5 provides an illustration of block diagram of the components of the secure physical layer post-processing device 300 in accordance with an exemplary embodiment of the present invention. As shown in the exemplary embodiment in FIG. 5, the secure physical layer post-processing device 300 can include one or more LFSRs 505 and one or more de-interleavers 510. In the exemplary embodiment shown in FIG. 5, the secure physical layer post-processing device 300 receives the input data to first LFSR 505, which outputs data to a first de-interleaver 510. The first de-interleaver 510 then outputs data to a second LFSR 510, which outputs data to a second de-interleaver 510. Thus, the exemplary embodiment of the secure physical layer post-processing processing device 300 provides a cascade of LFSRs 505 and de-interleavers 510 to post-process the data received by the reception device configured with the exemplary embodiment of the secure physical layer post-processing device 300. Those of skill in the art will appreciate that the secure physical layer post-processing device 300 can be configured to post-process the operations performed by the secure physical layer pre-processing device 200. For example and not limitation, in an exemplary embodiment, the secure physical layer post-processing device 300 can be configured with an equivalent number of LFSRs 505 and de-interleavers 510 to the number of LSRs 405 and interleavers 410 in the secure physical layer pre-processing device 200.

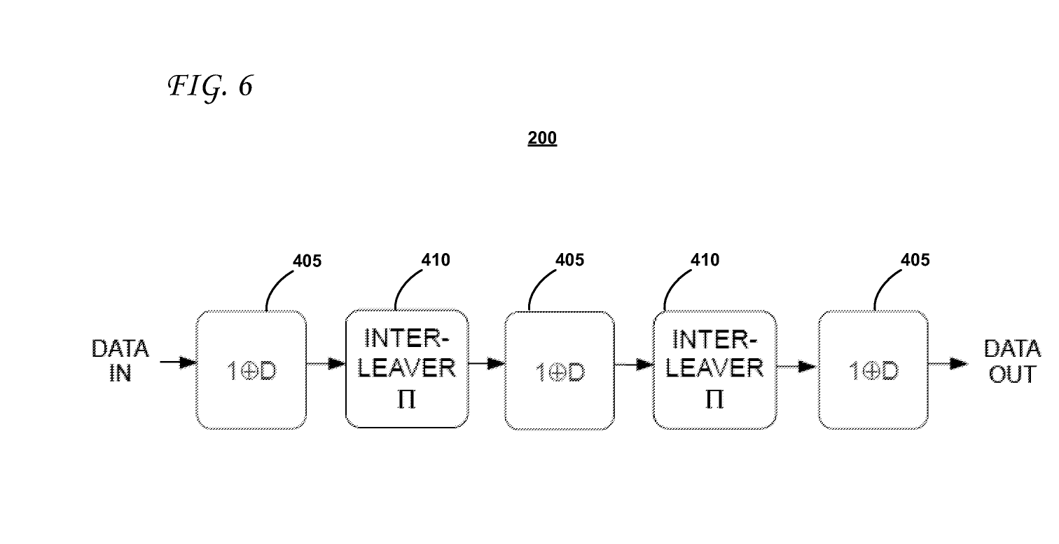

FIG. 6 provides an illustration of block diagram of the components of the secure physical layer pre-processing device 200 in accordance with an exemplary embodiment of the present invention. As shown in the exemplary embodiment in FIG. 6, the secure physical layer pre-processing device 200 can include one or more LSRs 405 and one or more interleavers 410. In the exemplary embodiment shown in FIG. 6, the LSRs 405 can be configured to implement an exclusive-OR operation (“XOR”) (modulo-2 addition) and insert a delay element (“D”) (“[1⊕D]”). In the exemplary embodiment shown in FIG. 6, the secure physical layer pre-processing device 200 receives the input data to first [1⊕D] LSR 405, which outputs data to a first interleaver 410. The first interleaver 410 then outputs data to a second [1⊕D] LSR 405, which outputs data to a second interleaver 410. The second interleaver 410 then outputs data to a third [1⊕D] LSR 405. Thus, the exemplary embodiment of the secure physical layer pre-processing device 200 provides a cascade of three [1⊕D] LSRs 405 and two interleavers 410 to pre-process the data to be transmitted by the transmission device configured with the exemplary embodiment of the secure physical layer pre-processing device 200. Those of skill in the art will appreciate that different embodiments of the LSRs 405 can implement different shift-register functions and [1⊕D] is just an example of such a function.

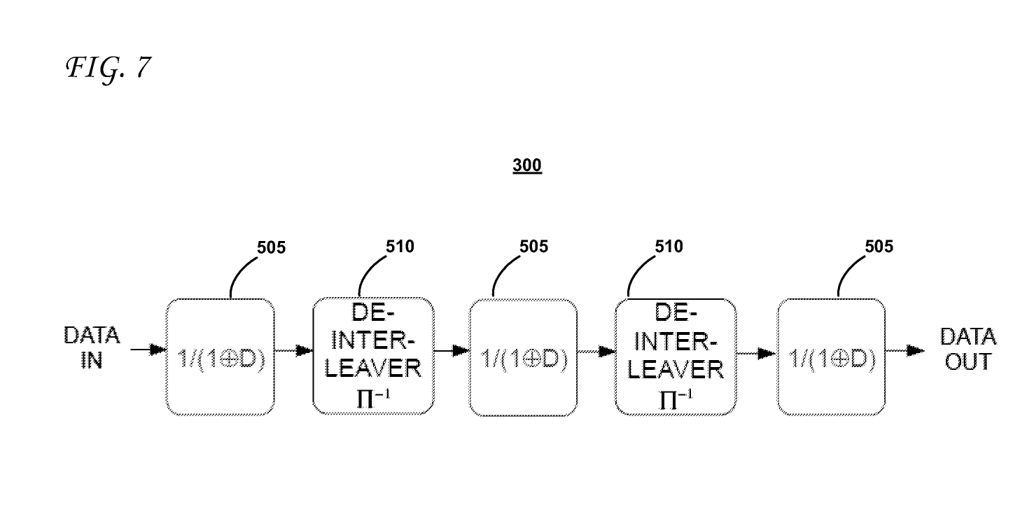

FIG. 7 provides an illustration of block diagram of the components of the secure secure physical layer post-processing device 300 in accordance with an exemplary embodiment of the present invention. As shown in the exemplary embodiment in FIG. 7, the secure physical layer post-processing device 300 can include one or more LFSRs 505 and one or more de-interleavers 510. In the exemplary embodiment shown in FIG. 7, the LFSRs 505 can be configured to implement the inverse of the exclusive-OR and delay operation implemented by the LSRs 405, thus [1/(1⊕D)] LFSRs 505. In the exemplary embodiment shown in FIG. 7, the secure physical layer pre-processing device 200 receives the input data to a first [1/(1⊕D)] LFSR 505, which outputs data to a first de-interleaver 510. The first de-interleaver 510 then outputs data to a second [1/(1⊕D)] LFSR 505, which outputs data to a second de-interleaver 510. The second interleaver 510 then outputs data to a third [1/(1⊕D)] LFSR 505. Thus, the exemplary embodiment of the secure physical layer post-processing device 300 provides a cascade of three [1/(1⊕D)] LFSR 505 and two de-interleavers 510 to post-process the data transmitted by the transmission device configured with the exemplary embodiment of the secure physical layer pre-processing device 200.

In an exemplary embodiment of the present invention, the secure physical layer pre-processing device 200 can increase the BER for an eavesdropper or unauthorized user of a wireless network 105. In a transmission network, a Binary Symmetric Channel (“BSC”) can have a BER with a probability of bit error “p”, 0≦p≦1. For an exemplary embodiment of the secure physical layer pre-processing device 200, the BER for an eavesdropper can be described as p′, where p′ is:

$${p}^{′} = {\sum }_{k = 1}^{[ \frac{w + 1}{2} ]} ( \frac{w}{2 k - 1} ) {( 1 - p )}^{w - ( 2 k - 1 )} {p}^{2 k - 1}$$

where “w” is the number of the channel bits participating in the post-processing for decoding of the information (message) data bit. In an exemplary embodiment implementing a secure physical layer pre-processing device 200, p′≧p for 0.0≦p≦0.5.

In one embodiment, the pre-processing performed by the secure physical layer pre-processing device 200 and the post-processing performed by the secure physical layer post-processing device 300 can be represented as modulo-2 matrix multiplications. In this embodiment, if M denotes the binary matrix for the equivalent modulo-2 matrix multiplication implemented by the secure physical layer post-processing device 300, then w for bit position i can be the number of 1's in the column number i of M.

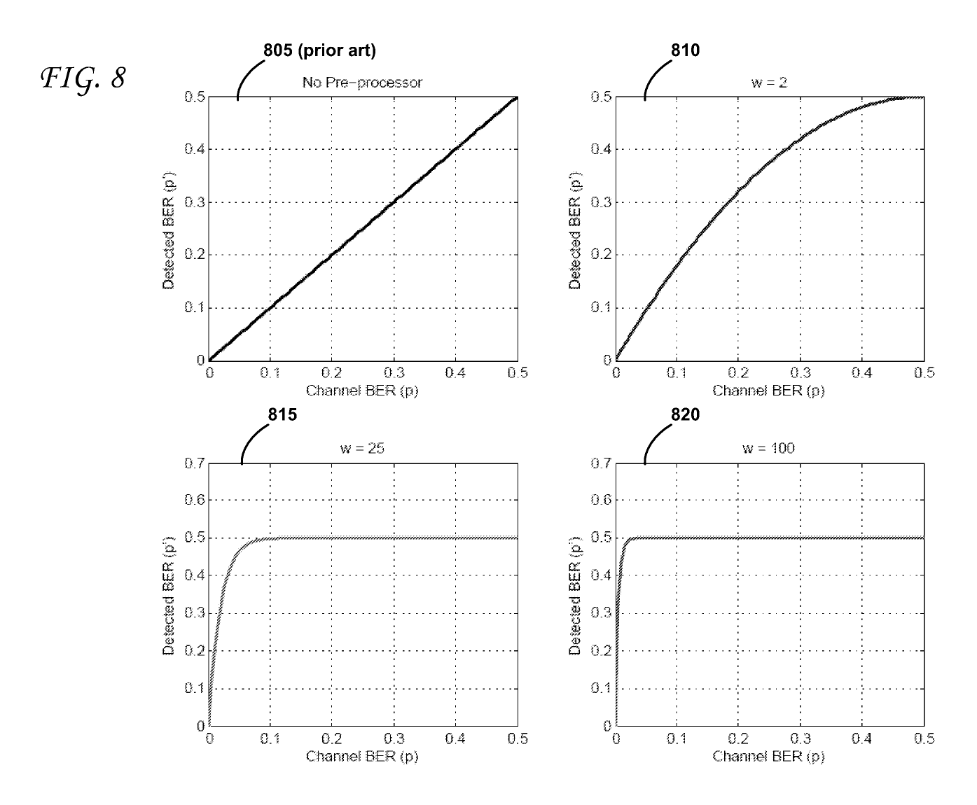

FIG. 8 provides graphs of the detected BER (p′) for both conventional reception device and reception devices having a secure physical layer post-processing device 300. Graph 805 of FIG. 8 shows an embodiment of the detected BER (p′) for data transmitted in conventional wireless systems without the benefit of the pre-processing by a secure physical layer pre-processing device 200 and post-processing by a secure physical layer post-processing device 300. As shown in graph 805 of FIG. 8, without the secure physical layer pre-processing device 200, the detected BER (p′) increases proportionally with the channel BER (p). Graphs 810, 815, and 820 provide illustrations of the detected BER (p′) for exemplary embodiment of the present invention having a secure physical layer post-processing device 300 at the reception device to post-process the data received from the secure physical layer pre-processing device 200 at the transmission device. Graph 810 illustrates the detected BER (p′) in a channel with a relatively small number of channel bits, i.e. w=2. Even with a relatively small number of channel bits, the processing by the secure physical layer pre-processing device 200 increases the detected BER (p′) for relatively low levels of channel BER (p). Additionally, as exhibited by graphs 815 and 820, the detected BER (p′) for exemplary embodiment of the present invention having a secure physical layer post-processing device 300 for w=25 and w=100, respectively, is significant for even the low values of channel BER (p). Thus the eavesdropper receives a high BER in an exemplary embodiment of the present invention for all levels of BER (p) present in the channel.

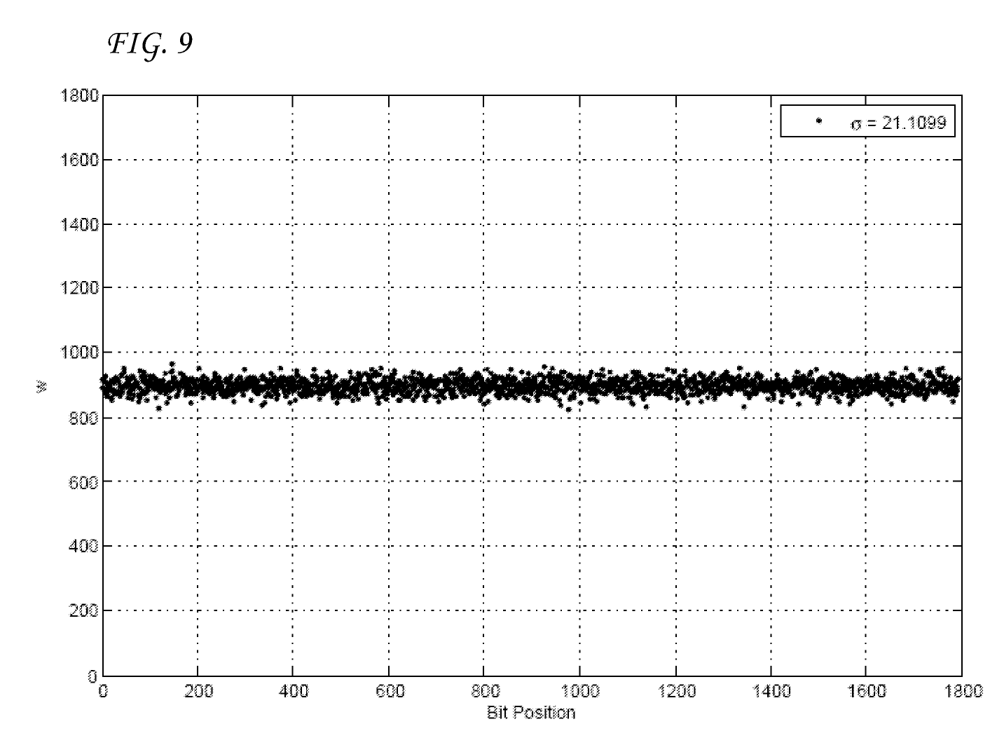

FIG. 9 is a graph of the number of channel bits (w) processed by a reception device, implementing a random matrix multiplier as a pre-processing device, versus the bit position. The number of channel bits (w) shown in FIG. 9 denotes the number of channel bits participating in post-processing by an exemplary embodiment of the secure physical layer post-processing device 300 to recover a particular information bit. In some embodiments of the present invention, it is desired to have the same level of physical layer security for the majority of bit positions. As shown in the graph of FIG. 9, the embodiment provides good characteristics for all bit positions, as the number of channel bits (w) is high (around 900) for almost all bit positions 0 to 1,800. Specifically, in the embodiment graphed in FIG. 9, w has a standard deviation (σ_{w}) of 21.1099 and a mean (μ_{w}) of 896.6350. Therefore, the embodiment shown in FIG. 9 provides essentially the same level of strong physical layer security for almost all bit positions.

While the random matrix multiplier implemented as a pre-processing device provides very good results for secure physical layer transmission, implementing a random matrix multiplier is not feasible in the large majority of implementations because of the expense of such a component. More particularly, random matrix multiplication is costly to implement in hardware. Therefore, it is desired to provide a cost effective solution for the pre-processing device.

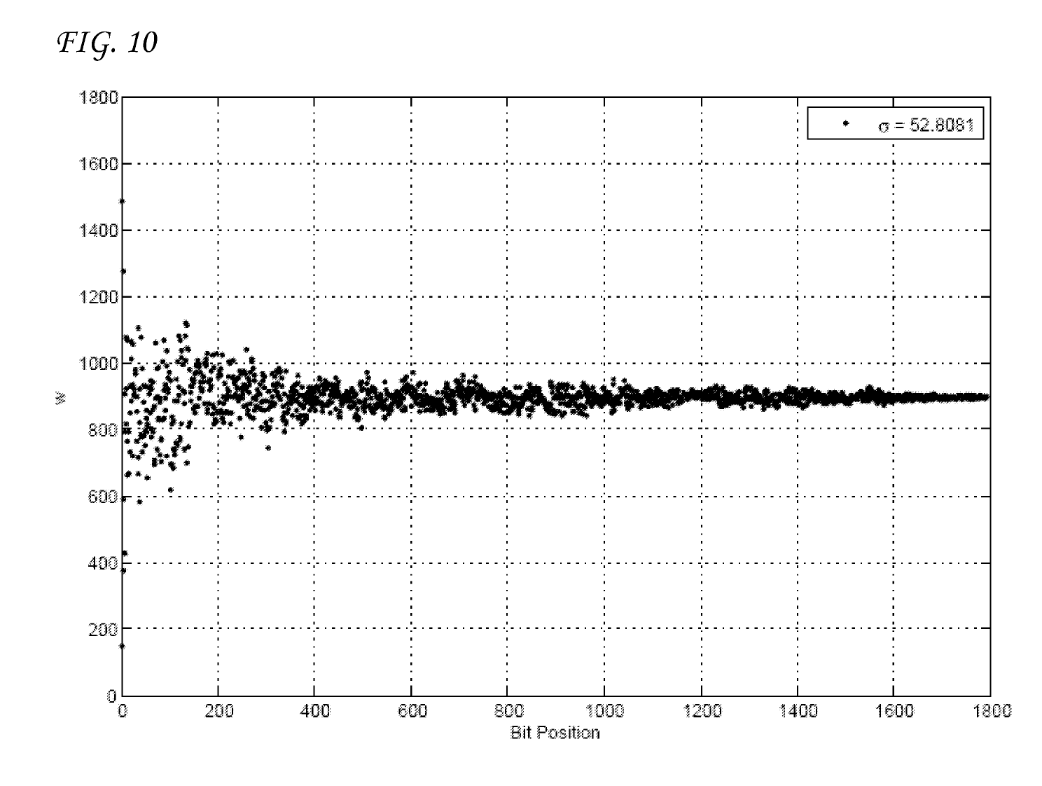

FIG. 10 is a graph of the number of channel bits (w) processed by a reception device including a secure physical layer post-processing device 300 receiving data from a transmission device including a secure physical layer pre-processing device 200. The information graphed in FIG. 10 was derived from a embodiment in which the secure physical layer pre-processing device 200 of the transmission device includes a cascade having a first [1⊕D] LSR 405 connected to a first interleaver 410 connected to a second [1⊕D] LSR 405. The graph shown in FIG. 10 illustrates that this exemplary embodiment of the secure physical layer pre-processing device 200 provides for reasonably good characteristics for the number of channel bits (w) processed by the reception device. Specifically, in the embodiment graphed in FIG. 10, number of channel bits (w) is shown to have a standard deviation (σ_{w}) of 52.8081 and a mean (μ_{w}) of 894.0714. While data relevant to the exemplary embodiment of the secure physical layer pre-processing device 200 shown in FIG. 10 provides good characteristics for the number of channel bits (w) for the majority of bit positions, this embodiment does exhibit less desirable characteristics for the number of channel bits (w) for the initial bit positions.

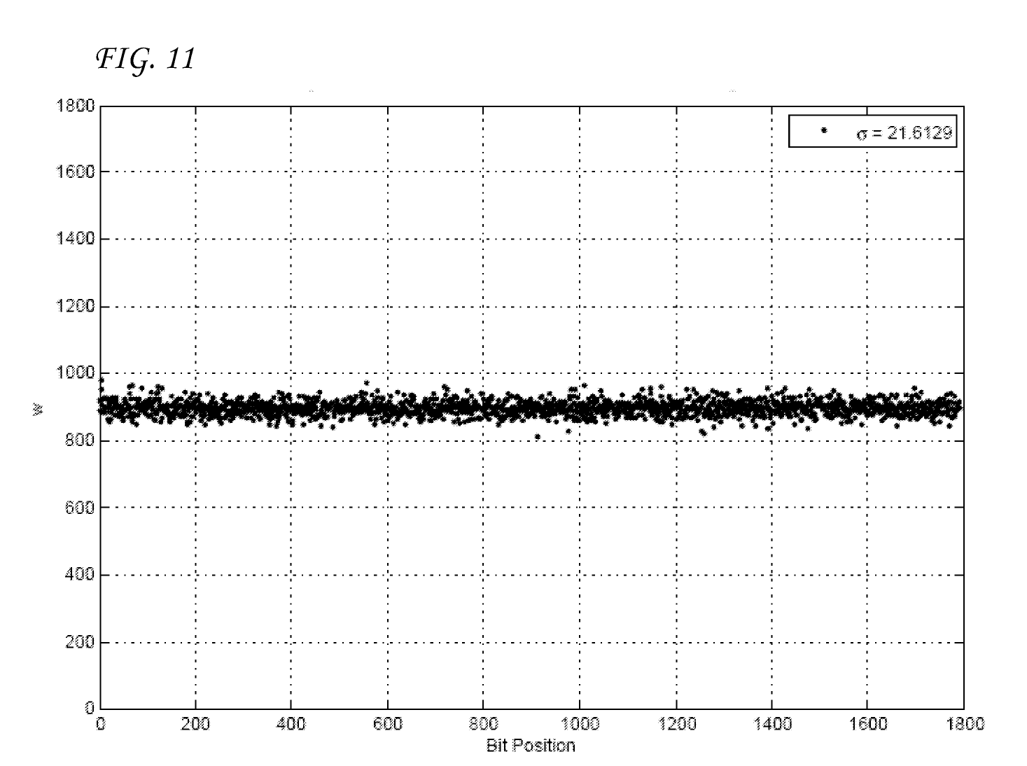

FIG. 11 is a graph of the number of channel bits (w) processed by a reception device including a secure physical layer post-processing device 300 receiving data from a transmission device including a secure physical layer pre-processing device 200. The information graphed in FIG. 11 was derived from a embodiment in which the secure physical layer pre-processing device 200 of the transmission device includes a cascade having a first [1⊕D] LSR 405, connected to a first interleaver 410, connected to a second [1⊕D] LSR 405, connected to a second interleaver 410, connected to a third [1⊕D] LSR 405. The graph shown in FIG. 11 illustrates that this exemplary embodiment of the secure physical layer pre-processing device 200 provides for very good characteristics for the number of channel bits (w) processed by the reception device for all bit positions. Specifically, in the embodiment graphed in FIG. 11, number of channel bits (w) is shown to have a standard deviation (σ_{w}) of 21.6129 and a mean (μ_{w}) of 896.4944. Unlike the data relevant to the exemplary embodiment of the secure physical layer pre-processing device 200 shown in FIG. 10, the secure physical layer pre-processing device 200 related to the data graphed in FIG. 11 provides for very good characteristics for the number of channel bits (w) for the initial bit positions.

Significantly, the exemplary embodiment of the secure physical layer pre-processing device 200 used to generate the data in FIG. 11 is relatively simple in terms of its hardware components, requiring only three LSRs 405 and two interleavers 410. Furthermore, as the FIG. 11 graph illustrates, the physical layer security for all the bit positions shown in FIG. 11 is roughly equivalent to the physical layer security provided by the expensive hardware implementation of a random matrix multiplier for the secure physical layer pre-processing device 200.

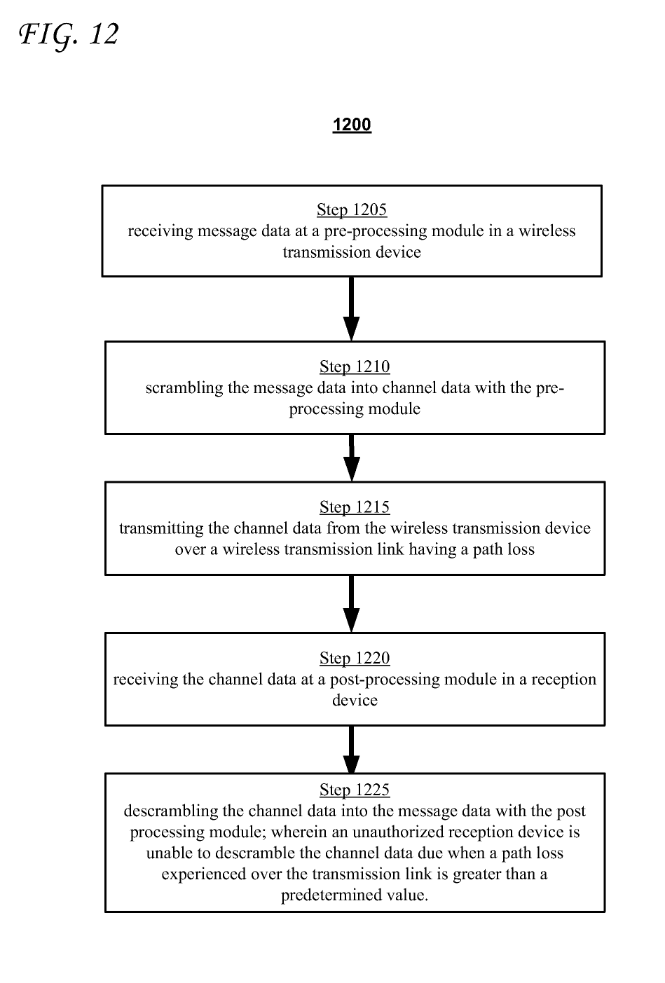

FIG. 12 provides an illustration of a block diagram of the method of providing physical layer security 1200 in accordance with an exemplary embodiment of the present invention. As shown in FIG. 12, the first step 1205 of an exemplary embodiment of the method of providing physical layer security 1200 involves receiving message data at a pre-processing device in a wireless transmission device. The second step 1210 of an exemplary embodiment of the method of providing physical layer security 1200 involves pre-processing the message data into channel data with the pre-processing device. The third step 1210 of an exemplary embodiment of the method of providing physical layer security 1200 involves transmitting the channel data from the wireless transmission device over a wireless transmission link having a path loss. The fourth step 1215 involves receiving the channel data at a post-processing module in a reception device. The fifth step 1220 of an exemplary embodiment of the method of providing physical layer security 1200 involves post-processing the channel data into the message data with the post-processing module, wherein an unauthorized reception device is unable to post-process the channel data due when a path loss experienced over the transmission link is greater than a predetermined value.

Those of skill in the art will appreciate that a wireless transmission link has a path loss exponent α resulting from reduction in power density (attenuation) of an electromagnetic wave as it propagates through space. In an exemplary embodiment, the power received by an unauthorized reception device at a distance dᵣ from the transmission device can be described as:

$${P}_{r} = {{P}_{0} ( \frac{{d}_{r}}{{d}_{0}} )}^{- α}$$

where P₀ is equivalent to the reference power at a distance d₀ from the transmission device.

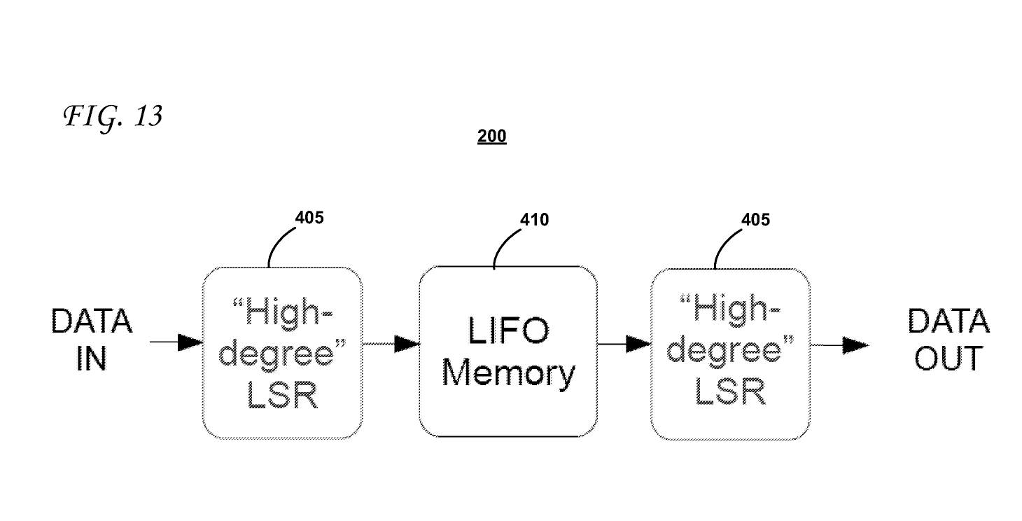

FIG. 13 provides an illustration of block diagram of the components of the secure physical layer pre-processing device 200 including a high-degree LSR 405 in accordance with an exemplary embodiment of the present invention. Those of skill in the art will appreciate the [1⊕D] LSR 405 is just one example of the possible types of LSRs 405 that can be implemented in the secure physical layer communication system 100 provided in accordance with an exemplary embodiment of the present invention. For example, and not limitation, the LSR 405 can be implemented as a primitive polynomial over the Galois field. Specifically, in one exemplary embodiment the secure physical layer pre-processing device 200 includes an high-degree LSR 405 with a memory size of 15 to implement a degree-15 primitive polynomial over the Galois field GF(2¹⁵). In another embodiment, the secure physical layer pre-processing device 200 includes an LSR 405 with a memory size of 8 to implement a degree-8 primitive polynomial over the Galois field GF(2⁸). In the exemplary embodiment shown in FIG. 13, the secure physical layer pre-processing device 200 includes a high-degree LSR 405. This high-degree LSR 405 can be implemented in an exemplary embodiment as a primitive polynomial over the Galois field, such as a primitive polynomial over GF(2¹⁵). Additionally, the exemplary embodiment of the secure physical layer pre-processing device 200 shown in FIG. 13 provides a Last-In First-Out (“LIFO”) memory device 1310. Therefore, in this exemplary embodiment of the secure physical layer pre-processing device 200 the LIFO memory device 410 can perform bit reversal on the information bits. The cascade configuration of the exemplary embodiment shown in FIG. 13 provides a first high-degree LSR 405 in communication with a first LIFO memory device 410 in further communication with a second high-degree LSR 405.

The configuration of the exemplary embodiment of the secure physical layer pre-processing device 200 shown in FIG. 13 has a relatively simplistic architecture. For example, and not limitation, the LIFO memory device 410 is a relatively simple and inexpensive memory device that only requires one memory unit, as opposed to the two memory units typically required by random interleavers. Furthermore, the exemplary embodiment of the LIFO memory device 410 does not require random access address generators or look-up tables, as there is no random interleaving to perform. Furthermore, the exemplary embodiment of the LIFO memory device 410 does not require variable size interleaves to support different sizes of pre-processing data blocks.

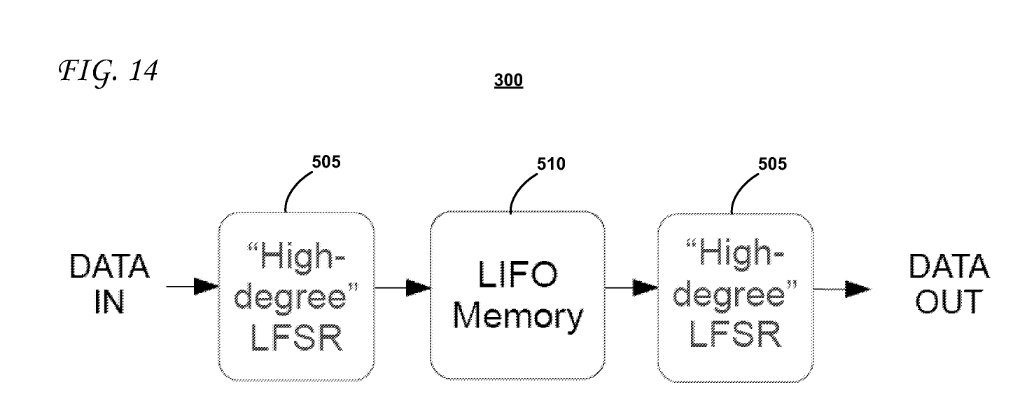

FIG. 14 provides an illustration of block diagram of the components of the secure physical layer post-processing device 300 including a high-degree LFSR 505 in accordance with an exemplary embodiment of the present invention. As shown in FIG. 14, the exemplary embodiment of the secure physical layer post-processing device 300 provides a high-degree LFSR 505 and a the LIFO memory device 510 to post-process the data received from an exemplary embodiment of the secure physical layer pre-processing device 200. The cascade configuration of the exemplary embodiment shown in FIG. 14 provides a first high-degree LFSR 505 in communication with a first the LIFO memory device 510 in further communication with a second high-degree LFSR 405.

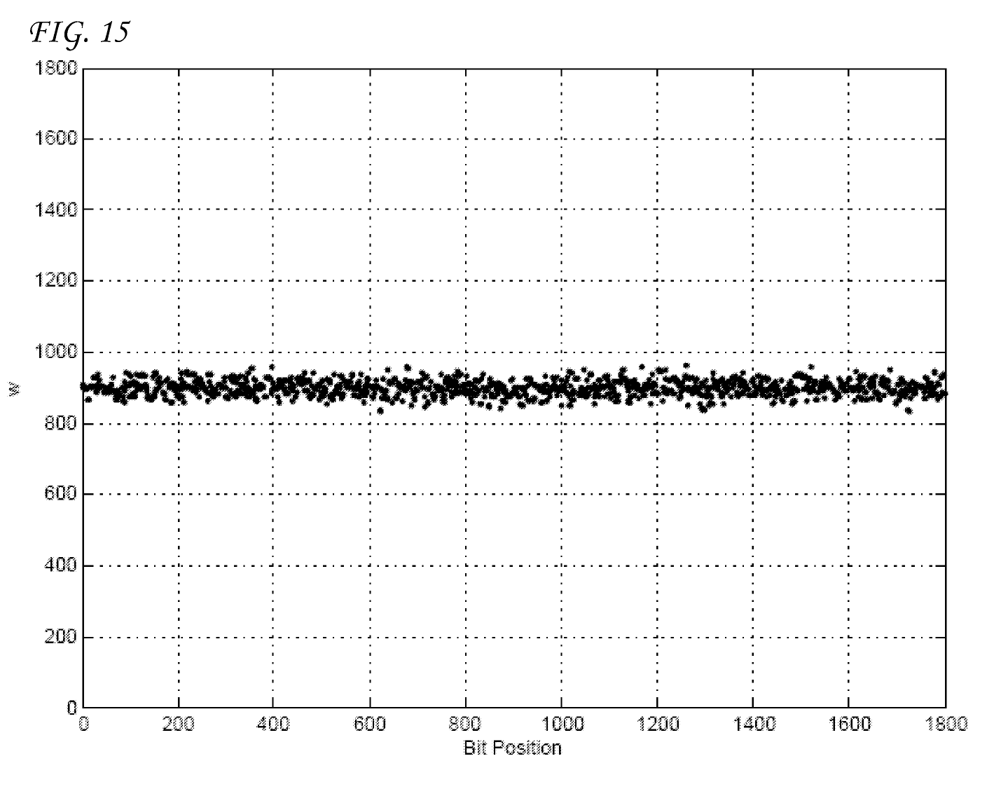

FIG. 15 is a graph of the number of channel bits (w) processed by a reception device including a secure physical layer post-processing device 300 receiving data from a transmission device including a secure physical layer pre-processing device 200. The information graphed in FIG. 15 was derived from an exemplary embodiment of the secure physical layer communication system 100, in which the secure physical layer pre-processing device 200 of the transmission device includes a cascade having a first high-degree LSR 405 in communication with a first LIFO memory device 410 in further communication with a second high-degree LSR 405. The graph shown in FIG. 15 illustrates that this exemplary embodiment of the secure physical layer pre-processing device 200 provides for very good characteristics for the number of channel bits (w) processed by the reception device for all bit positions.

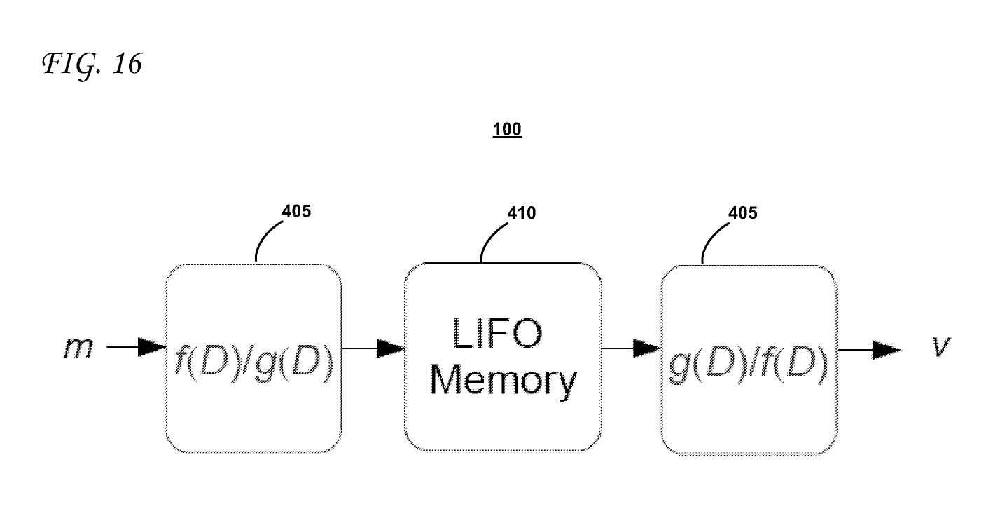

FIG. 16 provides an illustration of block diagram of the secure physical layer communication system 100, which can function as both a secure physical layer pre-processing device 200 and a secure physical layer post-processing device 300 in accordance with an exemplary embodiment of the present invention. The architecture of the exemplary embodiment shown in FIG. 16 is significant because this corresponding hardware unit can function as both the secure physical layer pre-processing device 200 and the secure physical layer post-processing device 300 in an exemplary embodiment without any hardware modifications. Those of skill in the art will appreciate that the object of the many embodiments of the secure physical layer communication system is to multiply the input data by a relatively large and dense matrix, in which around half of the entries are non-zero. For example, and not limitation, if m is a 1×N binary information vector, then 1×N vector v of the exemplary embodiment of the secure physical layer pre-processing device 200 can be described as v=m·S, where S is a dense and full rank N×N binary matrix. Generally, it would be cost prohibitive to provide the hardware capable of implementing such a relatively large matrix multiplication. The exemplary embodiment of the secure physical layer communication system 100 shown in FIG. 16 provides an effective and efficient solution for approximating this large matrix multiplication. As shown in FIG. 16, the secure physical layer communication system 100 provides a LSR 405 that that implements two randomly chosen polynomials, namely f(D)/g(D):

f(D)=1+f₁D+ . . . +fᵣD^{r}

g(D)=1+g₁D+ . . . +gₛD^{s}

where f(D) and g(D) are primate polynomials over GF(2^{r}) and GF(2^{s}). The cascade configuration of the exemplary embodiment of the secure physical layer communication system 100 shown in FIG. 16 provides a first f(D)/g(D) LSR 405 in communication with a first LIFO memory device 410 in further communication with a second g(D)/f(D) LSR 405. Importantly, the cascade of LSRs 405 and the LIFO memory device 410 is exactly the same in both the secure physical layer pre-processing device 200 and the secure physical layer post-processing device 300. This exemplary embodiment of the secure physical layer communication system 100 provides a significant advancement in that the hardware required for both the transmission device and the reception device is the same.

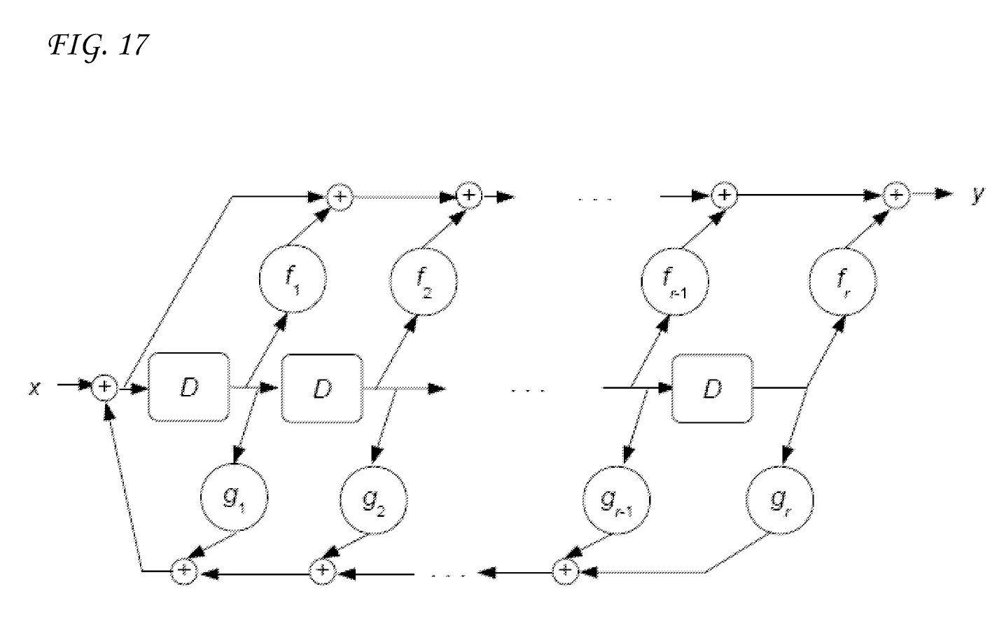

FIG. 17 provides an illustration of block diagram of recursive nature of the shift-register in the secure physical layer communication system 100 shown in FIG. 16. The f(D)/g(D) LSR 405 described for the exemplary embodiment of both the secure physical layer pre-processing device 200 and secure physical layer post-processing device 300 shown in FIG. 16 provides a recursiveness in the form of a feedback loop. As shown in FIG. 17, the rational transfer function f(D)/g(D) in controller canonical form can provide feedback at each level of the function. The recursiveness enabled by an exemplary embodiment of the f(D)/g(D) LSR 405 provides for both a dense pre-processing matrix and a dense post-processing matrix.

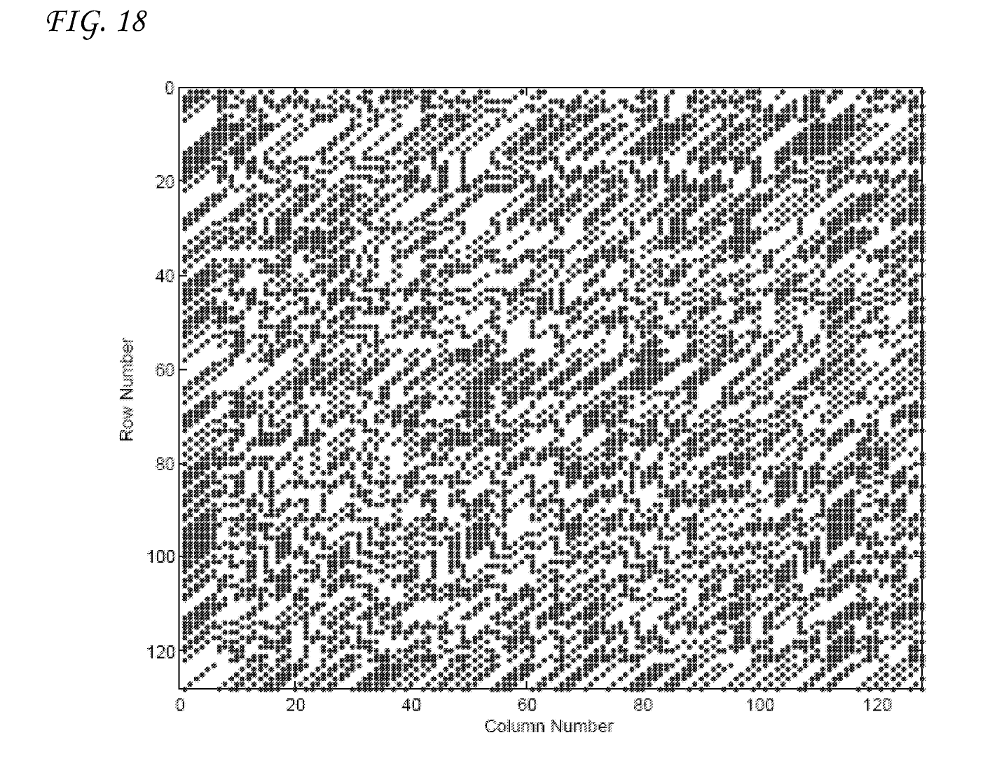

FIG. 18 is a graph of the post-processing matrix density showing the nonzero matrix entries for an exemplary embodiment of the secure physical layer communication system 100. The graph shown in FIG. 18 was derived from data relating to the secure physical layer communication system 100 embodiment shown in FIG. 16 implementing a recursive structure of LSRs. As shown in FIG. 18, the exemplary embodiment of the secure physical layer communication system 100 provides a dense and fairly evenly distributed post-processing matrix of channel data, having density=50.5249%. The column weight and row weight in the processing matrix provided by this exemplary embodiment of the secure physical layer communication system 100 are relatively evenly distributed around 64, ensuring virtually the same protection for all bit positions.

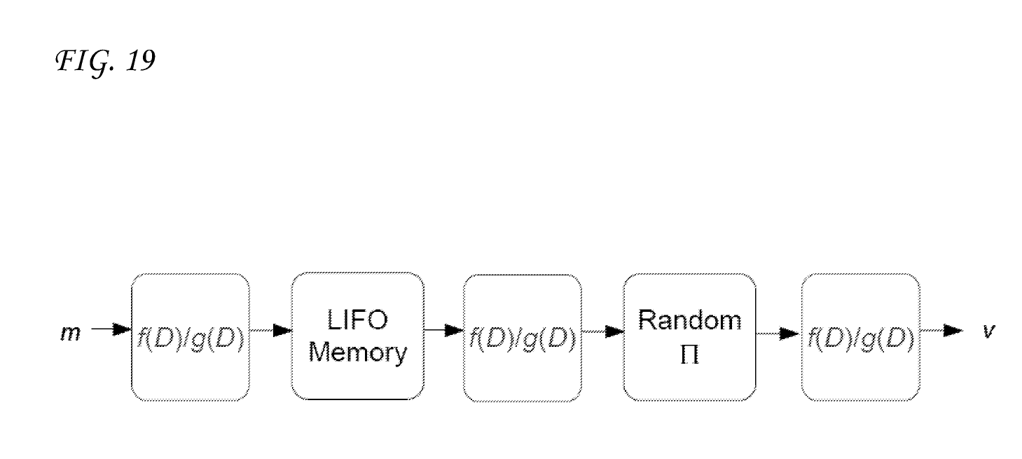

FIG. 19 provides an illustration of block diagram of the secure physical layer communication system 100 in accordance with an exemplary embodiment of the present invention. The exemplary embodiment of the secure physical layer communication system 100 shown in FIG. 19 provides a modified three-stage shift-register implementation, including a three f(D)/g(D) LSRs 405, a LIFO memory device 410, and a random interleaver 410. This modified configuration enables good pre-processing and post-processing properties by leveraging the benefits of each of the distinct components.

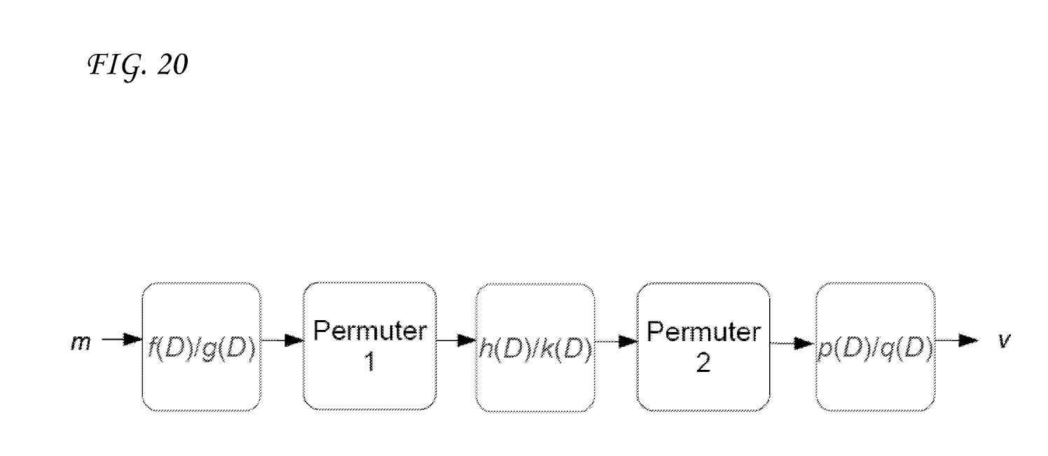

FIG. 20 provides an illustration of block diagram of the secure physical layer communication system 100 in accordance with an exemplary embodiment of the present invention. The exemplary embodiment of the secure physical layer communication system 100 shown in FIG. 20 provides distinct shift-registers at each stage, including f(D)/g(D) LSR 405, h(D)/k(D) LSR 405, and p(D)/q(D) LSR 405.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A method of providing physical layer security comprising:
receiving message data at a pre-processing device in a wireless transmission device;
pre-processing the message data into channel data with the pre-processing device;
transmitting the channel data from the wireless transmission device over a wireless transmission link having a path loss;
receiving the channel data at a post-processing module in a reception device;
post-processing the channel data into the message data with the post-processing module; and
wherein an unauthorized reception device is unable to post-process the channel data when a path loss experienced over the transmission link is greater than a predetermined value.

2. The method of providing physical layer security of claim 1, wherein path loss is greater than the predetermined value when the unauthorized reception device is greater than a first distance from the wireless transmission device.

3. The method of providing physical layer security of claim 1, wherein the path loss is greater than the predetermined value when the unauthorized reception device is outside a predetermined reception area for the wireless transmission device.

4. The method of providing physical layer security of claim 1, wherein pre-processing the message data is performed with at least one linear shift-register.

5. The method of providing physical layer security of claim 1, wherein pre-processing the message data is performed with a first linear shift-register in communication with a first interleaver, in further communication with a second linear shift-register.

6. The method of providing physical layer security of claim 5, wherein post-processing the channel data is performed with a first linear feedback shift-register in communication with a first de-interleaver, in further communication with a second linear feedback shift-register.

7. A secure physical layer communication system comprising:
a first shift-register device;
a Last-In First-Out (“LIFO”) memory device in communication with the first shift-register device; and
a second shift-register device in communication with the Last-In First-Out (“LIFO”) memory device.

8. The secure physical layer communication system of claim 7, wherein the secure physical layer communication system can both pre-process incoming message data and post-process incoming channel data.

9. The secure physical layer communication system of claim 7, wherein the first shift-register device and the second shift-register device include a shift-register that implements a primitive polynomial over a Galois field.

10. A secure physical layer pre-processing device comprising:
a first Linear Shift-register (“LSR”) in communication with an input of message data;
a first interleaver in communication with the first LSR; and
a second LSR in communication with the first interleaver, the second LSR having an output of channel data.

11. The secure physical layer pre-processing device of claim 10, wherein the first LSR and second LSR are high degree LSRs.

12. The secure physical layer pre-processing device of claim 10, further comprising a second interleaver in communication with the second LSR.

13. The secure physical layer pre-processing device of claim 12, further comprising a third LSR in communication with the second interleaver.

14. A secure physical layer post-processing device comprising:
a first Linear Feedback Shift-Register (“LFSR”) in communication with an input of channel data;
a first de-interleaver in communication with the first LFSR; and
a second LFSR in communication with the first de-interleaver, the second LFSR having an output of message data.

15. The secure physical layer post-processing device of claim 14, wherein the first LFSR and second LFSR are high degree LFSRs.

16. The secure physical layer post-processing device of claim 14, further comprising a second de-interleaver in communication with the second LFSR.

17. The secure physical layer post-processing device of claim 16, further comprising a third LFSR in communication with the second interleaver.

18. A method of providing physical layer security comprising:
receiving message data at a pre-processing device in a transmission device;
processing the message data at the pre-processing device with a first Linear Shift-Register (“LSR”);
processing the data at the pre-processing device with a first interleaver in communication with the first LSR;
processing the data at the pre-processing device with a second LSR in communication with the first interleaver;
outputting channel data.

19. A method of providing physical layer security of claim 18, further comprising:
receiving channel data at a post-processing module in a reception device;
processing the channel data at the post-processing module with a first Linear Feedback Shift-Register (“LFSR”);
processing the data at the post-processing module with a first de-interleaver in communication with the first LFSR;
processing the data at the post-processing module with a second LFSR in communication with the first de-interleaver;
outputting the message data.

20. The method of providing physical layer security of claim 19, wherein an unauthorized reception device is unable to post-process the channel data when a path loss experienced by the reception device is greater than a predetermined value.
